(19) United States
(12) Patent Application Publication
(10) Pub. No.: US 2008/0190821 A1
(43) Pub. Date: Aug. 14, 2008

(54) Method and Device for Cleaning Cereals

(75) Inventor: Walter Eugster, Niederuzwil (CH)

Correspondence Address: BUCHANAN, INGERSOLL & ROONEY PC, POST OFFICE BOX 1404, ALEXANDRIA, VA, 22313-1404, US

(73) Assignee: BUEHLER AG, Uzwil (CH)

(21) Appl. No.: 11/912,454

(22) PCT Filed: Mar. 15, 2006
(86) PCT No.: PCT/CH2006/000151

§ 371 Date: Jan. 15, 2008

(30) Foreign Application Priority Data
Apr. 27, 2005 (DE) 10 2005 019 998.4

(51) Int. Cl. B07B 1/28; B07B 1/55

(52) U.S. Cl. 209/311; 209/380

(57) ABSTRACT

The invention relates to method and device for cleaning grain, whereby a mixed product from cleaning is run through a light grain separator.

The invention relates to a method and a device for cleaning cereals, in particular for sorting out cereal grains loaded with contaminants, as well as for precision classification into several cereal qualities. The method and device are preferably, but not exclusively, used for the cleaning and grinding preparation of rolls.

Cereal, for example wheat or rye, can be cleaned wet and/or dry to remove dirt, loose husks or contaminants from the grain surface. In previous decades, dry cleaning has largely become the most popular. CH-A-640750 describes a method in which wheat is subjected to dry cleaning, including scouring. The wheat is then wetted and stored for several hours in quieting cells. After quieting, the wheat is husked immediately before the first grinding pass, wherein husking can be preceded by conditioning given a high husking degree. This depends on the husking degree and/or softening of the grains after wetting and quieting. Essentially, the process involves dry cleaning, moist shelling, intensive wetting and subsequent grinding.

According to CH-A-684576, the milling of cereal is preceded by wetting, quieting and husking, wherein husking can take place dry or wet, and pre-breaking takes place before milling.

It is also known to scour and polish wheat before milling, and then wet it. According to EP-B-529843, wetted and polished wheat can also again be cleaned wet to remove additional bran, in particular from the furrow.

The object of the invention is to develop a method for cleaning cereals, in particular wheat, which enables a further simplification of the cleaning process as well as decontamination, in particular a reduction in the mycotoxin load of the cereal grains and/or a precise classification or division of cereals into several quality levels. The object is achieved with the features in claim 1. According to the invention, a mixed product is relayed to a light-grain sorter for cleaning after the primary cleaning step. Surprisingly, this makes it possible to very distinctly reduce the share of grains and grain constituents loaded with mycotoxin, since not just loaded dirt, but also loosened husks and useless fines can be removed from the grain material early on.

Advantageous embodiments are described in the subclaims. For example, it may be advantageous, after the wetting and quieting that follows fine sorting, to scour and, if necessary, subject the cereal grains to impact and aspiration once again.

While sorting the grain material by specific weight is generally known, using this principle for decontaminating the grain material is not. The reduction of mycotoxin content in particular takes place via sorting, while impacting and aspiration help in the preparation. As opposed to conventional fine sorting, the capacity can be increased several times over, since the varying products can be better separated through the mentioned preparation.

The invention will be described in greater detail below in an exemplary embodiment based on a drawing. The drawing shows:

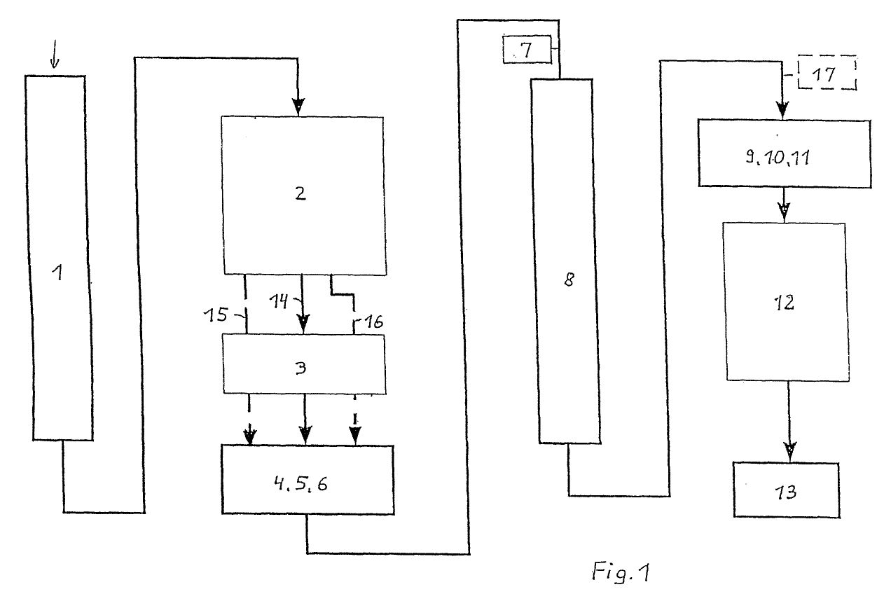

FIG. 1: a complete procedural diagram with all options,

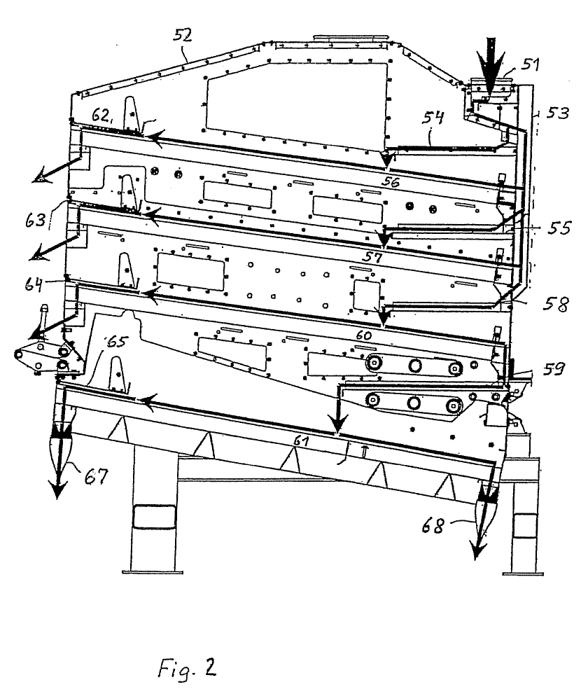

FIG. 2: A fine sorter.

Raw wheat from a raw wheat silo 1 is cleaned in a first cleaning step in a dry cleaner 2 according to EP-B-293426 of the applicant, and is relayed to a fine sorter 3. The mixed and fine product 14 then passes into a scouring machine 4, followed by an impact machine 5 and ending in an aspiration channel 6, where loose husk portions and the like are removed in the air stream. The wheat then arrives at an intensive wetter 7 for pre-wetting, and thereafter is intermediately stored in a quieting cell 8, for example for 60-90 minutes. If needed, another fine sorter 17 can be placed downstream from the quieting cell 8.

After this intermediate storage, the wheat is scoured in a second scouring machine 9, and subjected to additional impact and aspiration in a second impact machine 10 and a second aspiration channel 11. This is followed by husking or peeling of the wheat in a husking machine 7 of the kind disclosed in WO2004/060564 of the applicant. During this type of peeling, the cleaned, wetted and quieted wheat is again wetted on the surface as required, and subsequently husked in a husking machine 12. The husked product is relayed to pulverization 13

This approach can be shortened under the right circumstances, e.g., omitting the second scouring, impacting and aspiration process.

As an alternative, 100% product 16 or only the heavy product 15 could be supplied to the fine sorter 3, also making sure to monitor the contaminant content of the husks.

The dry cleaner 2 is a combination cleaning machine, in which sand and other contaminants are separated form the wheat on several upper screens, while light products such as loose husks, straw and the like are eliminated with the air stream passing through the grain material. The grain material to be processed further undergoes continued treatment on a lower concentrator deck and a rock sorter.

The fine sorter 3 has an inlet 51 on the screen box 52 for the wheat, wherein the inlet can be regulated by means of a slider (not shown).

Situated under the inlet 51 is a product divider 53, which preferably divides the incoming wheat uniformly via the return plate 54 or 55 on the two upper screen layers 56, 57. Additional such return plates 55, 58 and 59 are also arranged in front of or above the screen layers 59, 60, 61.

Situated at the top end of the inclined screen layers 56, 57, 60, 61 are end separating zones or end separating devices 62, 63, 64, 65, which each have a guard 66 for floating, light product and an adjustable perforated plate, wherein the slit holes can be altered in their open surface by means of an adjusting device. To this end, a counter-plate is shifted parallel to the perforated plate. The counter-air stream can hence be regulated. The respective heavier product sinks on the screen layers and passes down to the respective screen plate, and is conveyed to the upper end with the end separating devices 62-65 by the oscillating motion of the vibration drive (not marked).

No product falls through the screen plates of the screen layers 56, 57, 60, 61. The counter-air stream that penetrates the screen layers 56, 57, 60, 61 from below blows the respective lighter product up. The heavier product is rejected through outlets (not marked) after the respective end separating device 62-65, e.g., a heavy product after end separating devices 62 and 63, and a mixed product after the end separating device 64. After the end separating device 65, a corresponding light product arrives in an outlet 67.

The lighter product of the two upper screen layers 62 and 63 is relayed as a mixed product to the screen layer 60 via the product divider 58, and the light product formed there is relayed for sorting to the lowermost screen layer 61 via the product divider 59. The light scrap gets into the outlet 68. On the lowest screen layer 61, the end separating device 75 prevents the scrap from exiting with the lighter product through the outlet 67.

The inclination of the lowermost screen layer 61 can be varied with an adjusting device to influence product separation.

Wheat prepared for pulverization in this way is distinguished by a very low mycotoxin load, and additionally results in a high flour yield.

References

| | |
|---|---|
| 1 | Raw wheat silo |
| 2 | Dry cleaner |
| 3 | Fine sorter |
| 4 | Scouring machine |
| 5 | Impact machine |
| 6 | Aspiration channel |
| 7 | Intensive wetter |
| 8 | Quieting cell |
| 9 | Scouring machine |
| 10 | Impact machine |
| 11 | Aspiration channel |
| 12 | Husking machine |
| 13 | Pulverization |
| 14 | Mixed product |
| 15 | Heavy product |
| 16 | 100% product |
| 17 | Fine sorter |
| 51 | Inlet |
| 52 | Screen box |
| 53 | Product divider |
| 54 | Return plate |
| 55 | Return plate |
| 56 | Screen layer |
| 57 | Screen layer |
| 58 | Return plate |
| 59 | Return plate |
| 60 | Screen layer |
| 61 | Screen layer |
| 62 | End separating device |
| 63 | End separating device |
| 64 | End separating device |
| 65 | End separating device |
| 66 | Guard |
| 67 | Outlet |
| 68 | Outlet |

1. A method for cleaning cereals, in particular of wheat, via dry cleaning, wherein a mixed product is preferably relayed to cleaning (after cleaning) on a fine sorter.

2. The method according to claim 1, characterized in that fine sorting is followed by scouring, impacting and aspirating the light product.

3. The method according to claim 1 or 2, characterized in that fine sorting is followed by wetting and quieting the cereal grains.

4. The method according to one of claims 1 to 3, characterized in that quieting is followed by a second scouring, impacting and aspirating step.

5. The method according to at least one of claims 1 to 4, characterized in that the cereal is superficially wetted and then husked or peeled after quieted or after the second scouring, impacting and aspirating step.

6. The method according to claim 3, characterized in that the second scouring, impacting and aspirating step takes place after wetting or quieting.

7. A device for cleaning cereals, in particular of wheat, comprising a dry cleaner (2) and a fine sorter (3).

8. A device according to claim 7, characterized in that a scouring machine (4), impacting machine (5) and aspiration channel (6) are connected downstream from the fine sorter (3).

9. A device according to claim 7 or 8, characterized in that a second scouring machine (9), a second impacting machine (10) and another aspiration channel (11) are connected downstream from the fine sorter (3) after at least one quieting cell (8) for mixed product.

10. A device according to claim 9, characterized in that a husking machine (12) is connected downstream from the second aspiration channel (11).

11. A device according to at least one of claims 7 to 10, characterized in that the fine sorter (3) has a screen box (52) with at least two screen layers, through which air can be passed from below, and the screen box (52) is provided with at least one oscillating drive, wherein each screen layer (56, 57, 60, 61) contains an end separation zone or an end separating device (62-65).
